(19) United States
(12) Patent Application Publication
(10) Pub. No.: US 2006/0238532 A1
(43) Pub. Date: Oct. 26, 2006

(54) Ornamental LCD

(76) Inventor: Tamala M. LaFleur, Pulaski, VA (US)

Correspondence Address: James W. Hiney, Esq., Suite 1100, 1872 Pratt Drive, Blacksburg, VA, 24060, US

(21) Appl. No.: 11/285,545

(22) Filed: Nov. 22, 2005

Related U.S. Application Data
(60) Provisional application No. 60/636,977, filed on Dec. 17, 2004.

(51) Int. Cl. G09G 5/00

(52) U.S. Cl. 345/211

(57) ABSTRACT

An ornamental LCD capable of displaying full color photographs, video, text and graphics. The device contains a outer display screen with an LCD feature, a printed circuit board containing a memory module, a microprocessor, a USB connection and, in some cases, a power source. The device is adapted to have a fixed or snap-on ornamental face attached thereto to display information and can be manufactured as a Christmas tree ornament, desktop ornament, freestanding display or other display purposes.

This application is based upon provisional application No. 60/636,977 Filed Dec. 17, 2004 by the same inventor with the same title and reliance on the filing date and contents thereof is stated.

This invention relates to a device for displaying digital photographs and video including text and graphics. It consists of a base member with a circuit board for reciving signals and processing them and displaying them on an LCD display.

### BACKGROUND ART

There are no direct similar devices. Some of these are sold by companies such as Eframecentral which shows its products at eframecentral.com. However, the filing date of the provisional case upon which this application is based precedes the availability of those devices.

There are also digital devices which store pictures and print them out and an example of which is the Kodak EasyShare picture viewer. It allows a user to carry pictures around to display when the situation affords an opportunity.

There is essentially no background art which accomplishes what the instant invention does. While there has been use of digital photo display frames in the past these devices are merely for receiving inputs of photos, storing them and allowing the user to selectively display them at his or her option. They use the medium of a miniature storage card or Compact Disc to store the images and/or print them for other uses.

The ability to display digital pictures and video has heretofore been limited to taking the time to load all of the photos or video into a computer for viewing or the insertion of the digital cameras miniature storage card into a display device.

### BRIEF DESCRIPTION OF INVENTION

As over 30% of U.S. households now own digital cameras there is an ever-increasing need to allow users to display their digital photos. Unlike as in years past today's camera enthusiasts wish to see their photos on an almost immediate basis and not plow though tons of old photo albums.

The instant device allows a user to display various photographs with photos and text or to display digital video in connection with an ornamental display. One embodiment of the invention is a Christmas tree decoration which shows photos or video which can be a reminder of Christmases past or the present Christmas. The device contains a printed circuit board which contains a microprocessor, a non-volatile memory module(s), a universal serial bus (USB) connection, a power supply connection (or a power supply) and connectors for connecting to a backlit color liquid crystal display (LCD). The LCD is backlit and capable of displaying text, graphics, images and video.

There can be an optional sound board to capture the utterance of children or whatever person or scene is being displayed to accompany photos or as part of the video stream. The device can be powered by the lights of the Christmas tree, from an AC wall adaptor, from a computer USB power tap or battery. It can manage either DC or AC power.

The images are loaded into the device through a USB device from either a personal computer or digital camera and stored in the internal memory module. Image transitions can be affected by software techniques, which allow length of time for display of images, fade in, fade out, wipes, slides and a variety of other transactions. Text messages can also be loaded to personalize the device.

One feature of the device allows for permanent retention of the images that cannot be erased by the end user. This allows for commercial use of sport or promotional events. As an example, a NASCAR racecar driver or Disney character being loaded into the device as the cycle of end users runs through the display of the Sport or Promotional event is then displayed.

A still further feature is to allow for autograph sessions expanded into digital photo sessions with the instant device. These are put in the reserved session memory section that cannot be changed or erased by the end user. One can have a theme park record your ride on a notable thrill ride and then load them into the reserved memory area of the device.

The main appeal of this device is the ability to display these photos or video without a computer thus allowing a large portion of the consuming public to use it which normally are “put off” by computers.

### OBJECTS OF THE INVENTION

Accordingly it is an object of the invention to provide an ornamental LCD device for display of digital information including photo, text, graphics and video,

Another object of this invention is to provide an ornamental LCD device which contains a microprocessor, non-volatile memory modules, USB connection, power supply connection, and connection to a liquid crystal display panel,

Yet another object of this invention is to provide an ornamental LCD device which also can record and playback sound therein,

Still another object of this invention is to provide a novel LCD display device which can have different ornamental faces thereon to change the image thereof,

It is a still further object of this invention to provide a unique way to display digital images,

These and other objects will become apparent when reference is had to the accompany drawings in which

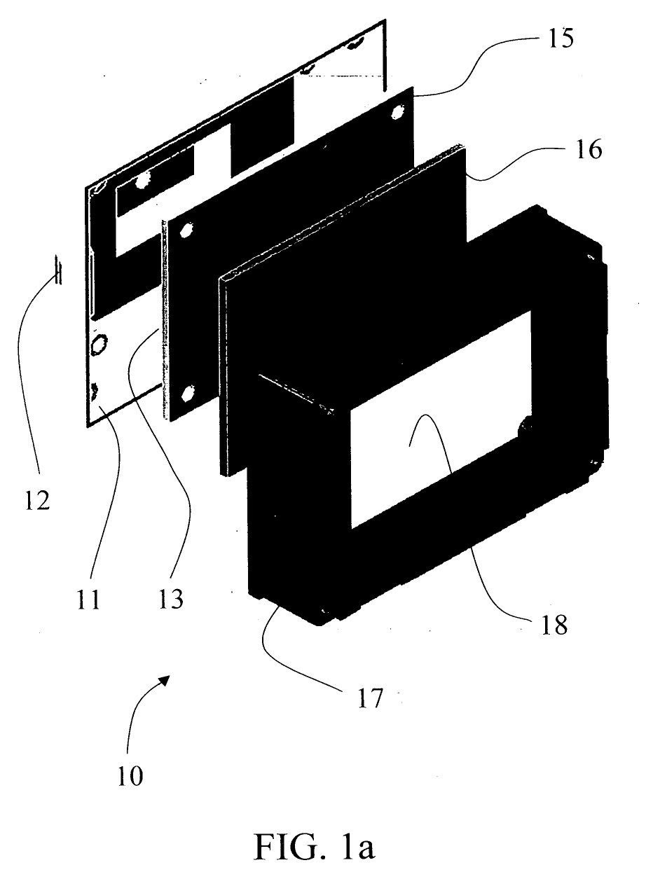

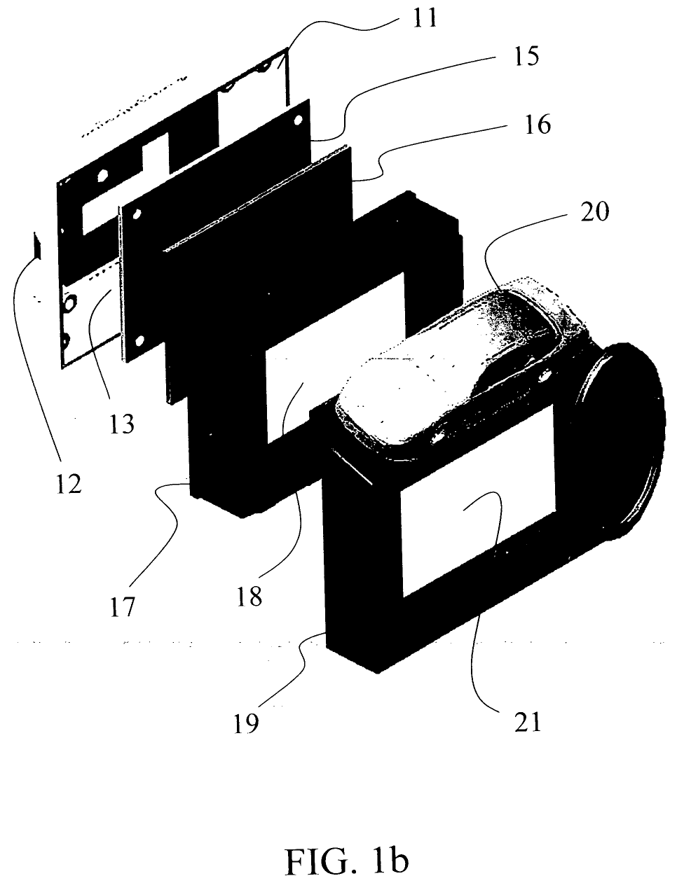

FIGS. 1a and 1b show exploded views of one embodiment of the invention.

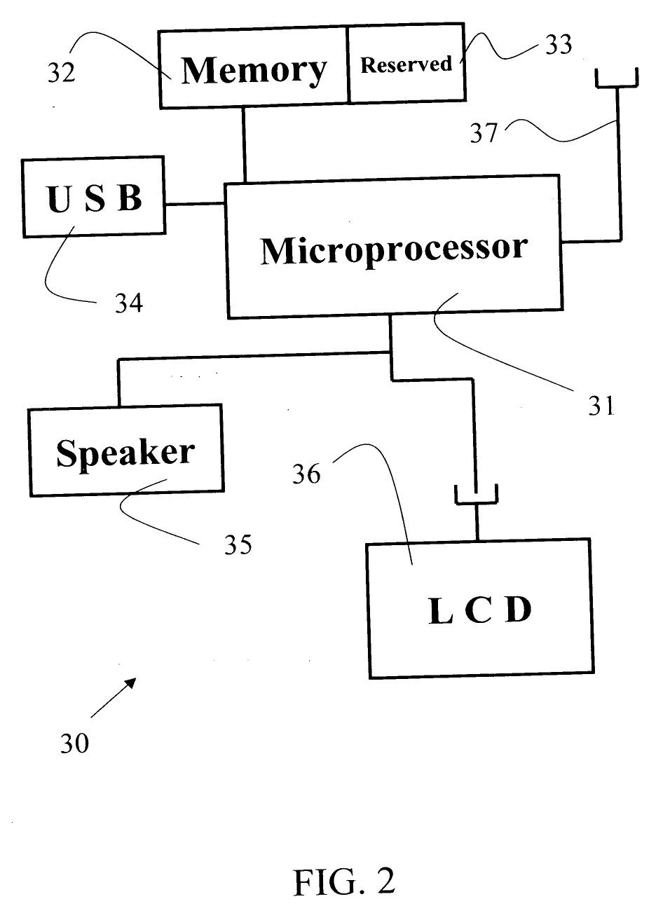

FIG. 2 shows a flow diagram of the electronics of the invention

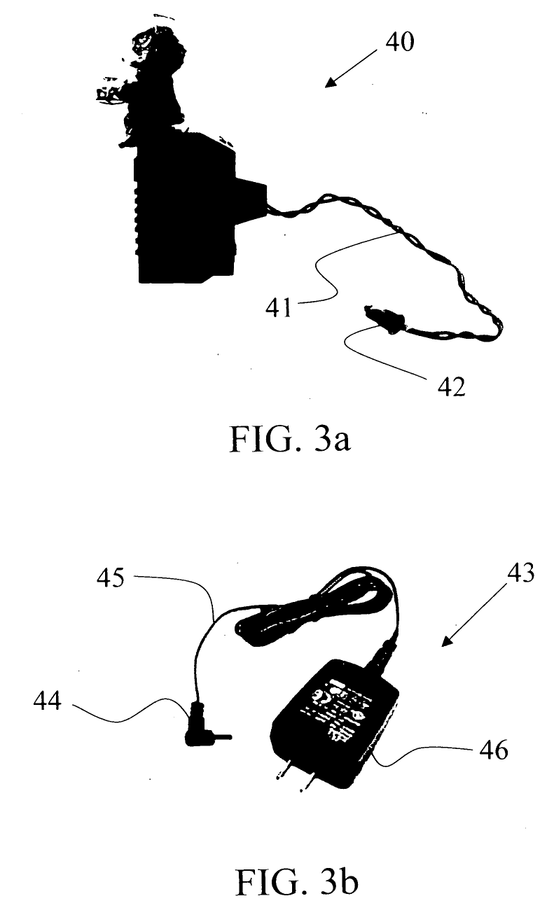

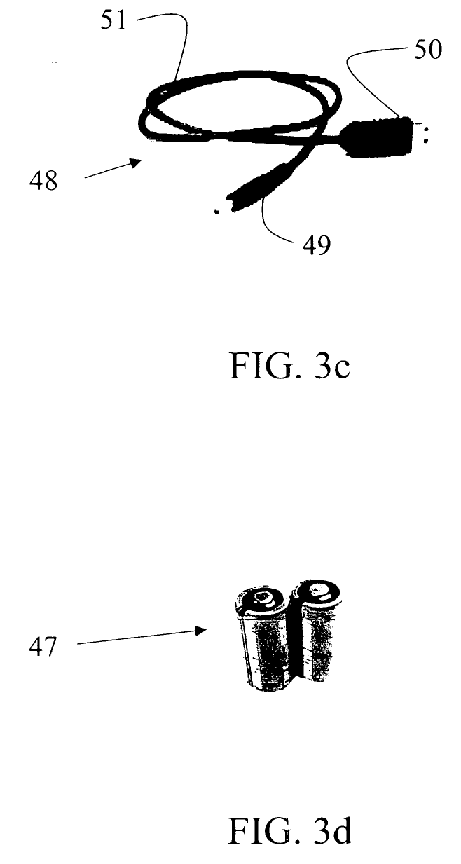

FIGS. 3a through 3d show various power supplies for the invention,

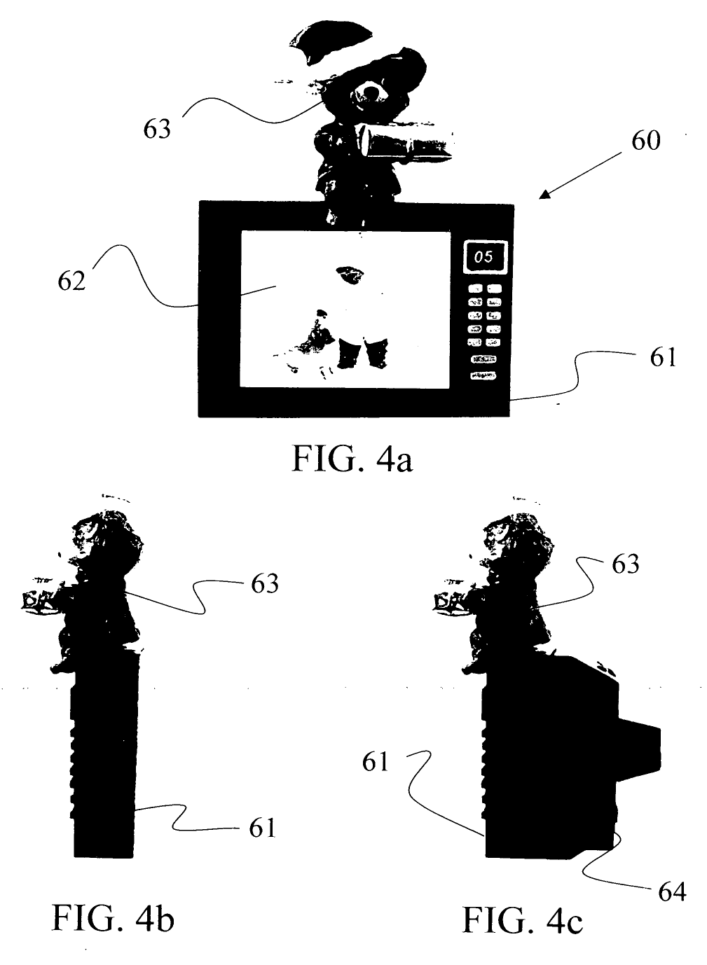

FIGS. 4a through 4c show one embodiment of a mechanical display attachment,

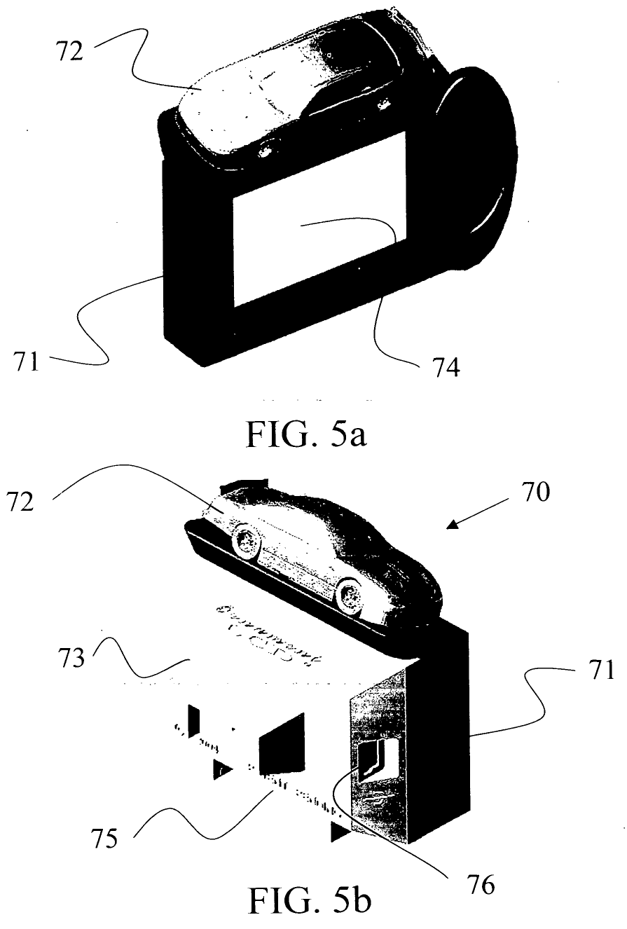

FIGS. 5a and 5b show an embodiment of the invention wherein the decorative attachment is in the form of a racing car,

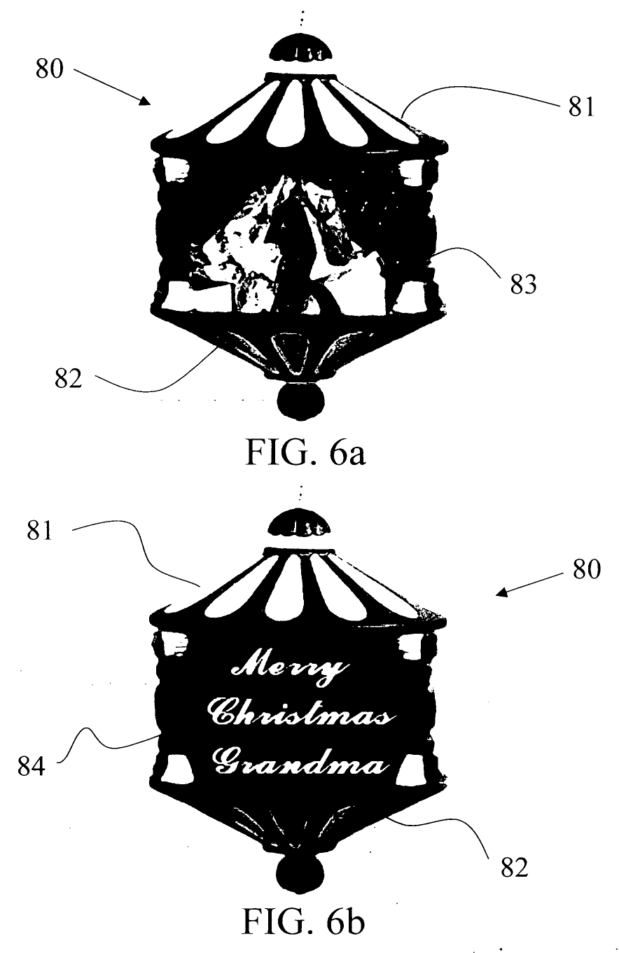

FIGS. 6a and 6b shows an embodiment of the invention within a Christmas tree ornament displaying both a photo and text,

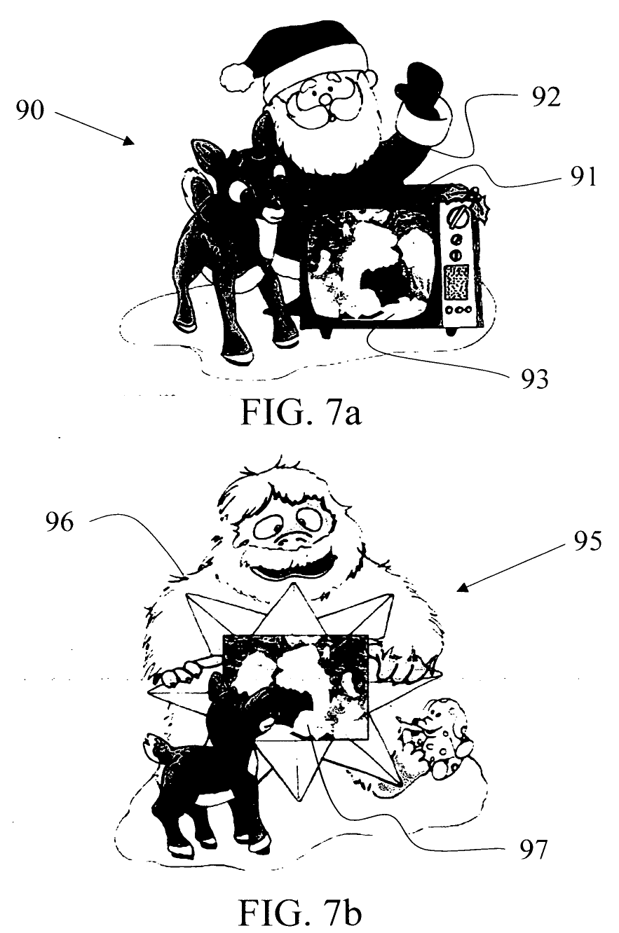

FIGS. 7a and 7b show two more embodiments of the invention used in tabletop ornamental displays,

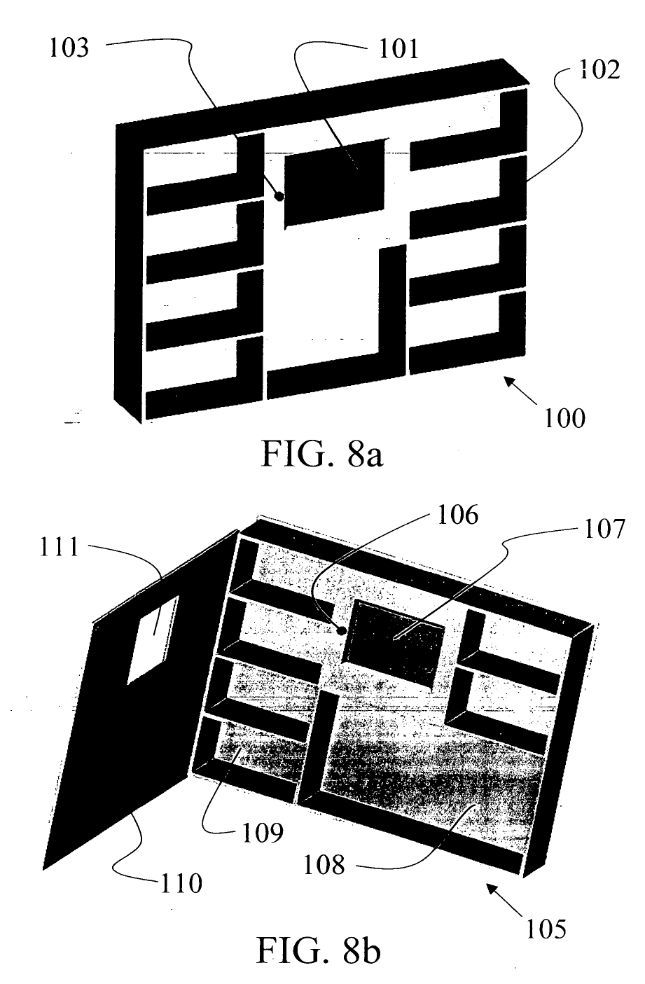

FIGS. 8a and 8b show two more embodiments of the invention used in a shadow box or keepsake photo album ornamental displays.

### DETAILED DESCRIPTION OF THE INVENTION

Referring now to FIGS. 1a and 1b there is shown the an embodiment of the invention used for display purposes designated generally as 10 which includes main support structure 11 with a USB connection port 12. Nestled within the structure 11 is a circuit board 15 having a microprocessor and memory module and LCD panel 16. Connections run along the structure 11 to connect the various portions of the device. A faceplate member 17 secures the members 15 and 16 within structure 11 and has an opening 18 therein to allow viewing of the LCD panel. Within the structure 11 is a grated structure opening 13 which provides for ventilation and a location for an optional diaphragm for sound output. As shown in FIG. 1b a decorative front 19 is adapted to be affixed or “snapped” atop member 17 to allow various ornamental fronts to be used. The particular one shown has a automobile representation 20 thereon. Area 21 is an opening to allow viewing of the LCD panel.

FIG. 2 shows the electronics of the inventions designated generally as 30. It consists of a microprocessor 31, a non-volatile memory 32, reserved non-volatile memory 33, USB 34, a power supply connection 37, a speaker (optional) 35 and an LCD unit 36.

FIGS. 3a through 3d show the various types of power supply that can be used with the invention. FIG. 3a shows a mini-light connection 40 having cord 41 and plug-in portion 42. FIG. 3b shows an AC adapter 43 with cord 45, transformer 46 and plug 44 for attaching to the unit shown in FIG. 3a. FIG. 3c designated generally as 48 shows a USB power tap 50 with cord 51 and plug unit 49. FIG. 3d shows batteries designated generally as 47.

FIGS. 4a through 4c show one embodiment of the ornamental LCD device noted as 60. It has a frame 61 with an aperture 62 therein so as to show the LCD display and a ornamental FIG. 63 atop the device. This faceplate can be affixed or “snapped” onto the electronics structure of the invention 64 along with other such ornamental devices.

FIGS. 5a and 5b show another embodiment of the invention as 70 with a ornamental frame 71, an aperture 74 for the LCD display to show through, an automobile representation 72 and an area 75 which can be used as a speaker aperture if sound is desired. A USB connection is shown at 76 in structural member 73 to which the ornamental device 71 is attached.

FIGS. 6a and 6b show another embodiment 80 which is configured as a Christmas tree ornament. It has a top portion 81 and a bottom portion 82. In one showing a photo 83 is displayed whereas in the other showing a text message 84 is displayed.

FIGS. 7a and 7b show alternate Christmas season embodiments where the devices such as 90 have a Santa representation 92 together with a TV representation 91 with LCD display 93 and, in FIG. 7b, a snow monster representation 96 and an LCD display 97 which can be used as a tabletop display.

FIGS. 8a and 8b show alternate Shadow Box and Keepsake Box Photo Album embodiments where the devices such in FIG. 8a represents a Shadow Box designated generally as 100 with various compartments 102 for holding memorabilia together with an aperture 101 for the LCD display to show through, with a switch 103 used to active the device. FIG. 8b represents a Keepsake Box Photo Album designated generally as 105 with various storage compartments 109 and a compartment designed for storing hardcopy printed photographs 108 and an outer hinged front cover 110 together with an aperture 111 for the LCD display 107 to show through, a push button or plunger switch 106 is used to active the LCD display when the front cover 110 is opened.

Having described several embodiments of this invention it will be obvious to those of ordinary skill in the art that many changes and modifications can be made without departing from the scope of the appended claims.

What is claimed is:

1. An ornamental device for displaying digital photos, text, graphics and video medium, said device comprising
a base member of a shape to receive the medium,
said base member having a connection means for connecting to a power source,
a circuit board inserted into said base member,
an LCD display panel in said base member adjacent said circuit board,
said circuit board having electronic circuit means thereon for receiving the medium and transmitting it to said LCD display panel for display, and
a face plate means secured to said base member and securing said LCD panel and circuit board within said base member,
an ornamental member attached to said face plate so as to be removable in favor of another ornamental member.

2. A device as in claim 1 wherein said circuit board contains a microprocessor.

3. A device as in claim 1 wherein said circuit board contains a speaker to facilitate an audio component to said display.

4. A device as in claim 2 wherein said circuit board also contains a non-volatile memory means.

5. A device as in claim 1 wherein said base member has electronic connections connecting said connection means to said circuit board and said LCD to said circuit board.

6. A device as in claim 5 wherein said electronic connections are etched circuits in said base member.

7. A device as in claim 1 wherein said ornamental member has a representation of an automobile thereon.

8. A device as in claim 1 wherein said ornamental member is in the form of a “Shadow Box” with various compartments.

9. A device as in claim 1 wherein said ornamental member is in the form of a Keepsake Box Photo Album.

10. A device as in claim 1 wherein said ornamental member is in the form of a Christmas tree ornament.

11. A device as in claim 1 wherein said ornament has a connecting cord to attach the member to electrical Christmas tree lights for a power tap.

12. A device as in claim 1 wherein the connection means is a USB connection with power tap.

13. A device as in claim 1 wherein the connection means is adapted to connect to batteries contained in said ornamental device.

14. A device as in claim 1 wherein said connection means is a AC adapter with cord and transformer.

15. A device as in claim 9 where the opening of the cover activates the electrical circuit switch for activation of the device.

16. A device as in claim 10 and including a hook means to hang the device on a Christmas tree.

17. An ornamental device for displaying digital photos, graphics, text and video, said device comprising
A main member having circuit means for receiving and displaying a digital or video signal, said member having means to attach it to a power source,
A removable ornamental portion affixed to said main member to surround the display caused by said main member,

18. A device as in claim 17 wherein said main member circuit means includes a microprocessor and non-volatile memory means.

19. A device as in claim 17 wherein said means for attaching said main member to a power source is a Christmas tree light connector.

20. A device as in claim 17 wherein said ornamental member is adapted to snap on and off of said main member.

21. A device as in claim 17 which also include means for receiving and amplifying an audio signal.

22. A device as in claim 17 wherein said circuit means includes an LCD display.
